(19) United States
(12) Patent Application Publication
(10) Pub. No.: US 2007/0097024 A1
(43) Pub. Date: May 3, 2007

(54) Multi-channel imaging system

(75) Inventors: Sung-yong Jung, Suwon-si (KR); Dae-sik Kim, Suwon-si (KR); Kyung-hoon Cha, Yongin-si (KR); Tae-hyeun Ha, Suwon-si (KR); Jae-phil Koo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/546,992

(22) Filed: Oct. 13, 2006

(30) Foreign Application Priority Data
Oct. 13, 2005 (KR) 10-2005-0096501

(51) Int. Cl. G09G 3/00

(52) U.S. Cl. 345/32

(57) ABSTRACT

A multi-channel imaging system that allows multiple viewers to simultaneously see different images in full-screen on a single screen includes: a mode selector which selects a general 2D mode, a multi-channel 2D mode, or a 3D mode; a source selector which provides an image from at least one channel; a conversion unit which interlaces two images received from the source selector so that they alternate with each other when the multi-channel mode or the 3D mode is selected; a display which displays the alternating two images received from the conversion unit so that they have orthogonal polarizations; 3D polarizing glasses which provide a different image to the left eye and to the right eye when the 3D mode is selected; and a pair of multi-channel polarizing glasses each of which provides a user with only one of two images being displayed when the a multi-channel 2D mode is selected.

### CROSS-REFERENCE TO RELATED PATENT APPLICATIONS

This application claims priority from Korean Patent Application No. 10-2005-0096501, filed on Oct. 13, 2005, in the Korean Intellectual Property Office, the disclosure of which is incorporated herein in its entirety by reference.

### BACKGROUND OF THE INVENTION

1. Field of the Invention

Apparatuses consistent with the present invention relate to a multi-channel imaging system, and more particularly, to a multi-channel imaging system that allows multiple viewers to simultaneously see different images in a full-screen mode on a single screen.

2. Description of the Related Art

Currently, televisions (TVs) or monitors employing a multi-channel, imaging system that can display a plurality of different images on a single screen are being widely used. Typically, a multi-channel imaging system can be implemented using a Picture in Picture (PIP) feature whereby a small sub-screen is displayed in a corner of a main screen as shown in FIG. 1A or using a double screen function whereby two images of the same size are displayed on the left and right sides of a screen as shown in FIG. 1B.

However, a multi-channel imaging system realized using the methods as shown in FIGS. 1A and 1B cannot display each image in a full-screen. Another drawback is that when a user intends to view only the desired image, a plurality of other images displayed are likely to irritate the user's eyes. In the PIP mode shown in FIG. 1A, a portion of the main screen is hidden by the sub-screen. In the double screen mode shown in FIG. 1B, an image displayed on the screen is distorted, i.e., vertically lengthened because the horizontal dimension of the image is reduced compared to an original image size.

Thus, to overcome the drawbacks, a multi-channel imaging system that allows multiple users to view their desired images as a full-screen image on a single screen without being irritated due to the presence of other images has been proposed.

FIG. 2 shows a related art multi-channel imaging system proposed in Japanese Patent Publication No. 62-65580. Referring to FIG. 2, in the conventional multi-channel imaging system, multiple users 11 through 13 wear glasses 14 through 16, respectively, to selectively view one of images A, B, and C sequentially displayed on a display device 10 at high speed. The glasses 14 through 16 may have a liquid crystal shutter. The liquid crystal shutter is open when the desired image is displayed and closed for when other images are displayed. Thus, a user can selectively view one of images A, B, and C by allowing the shutter to open and close in synchronization with the display of the appropriate image on the display device 10. However, in the conventional multi-channel imaging system, the image scanning speed of the display device 10 and the liquid crystal shutter speed of the glasses 14 through 16 must be sufficiently high to prevent flickering. Also, the liquid crystal shutters of the glasses 14 through 16 must be very precisely synchronized with the display device 10.

FIG. 3 shows a related art multi-channel imaging system disclosed in Japanese Patent Publication No. 62-91926. Referring to FIG. 3, in the multi-channel imaging system, two images from projectors 20 and 20′ are transmitted through a polarization plate 22 or 22′ and projected onto a screen 23. Multiple users wear one of two orthogonal polarizing glasses 24 and 24′ to view an image. In this case, because an image having a polarization orthogonal to that of polarizing glasses that a user wears occludes, the user is able to selectively view only an image having the same polarization as that of the polarizing glasses. However, the multi-channel imaging system of FIG. 3 can apply only to a projection structure and requires an expensive polarization-preserving screen.

### SUMMARY OF THE INVENTION

The present invention provides a multi-channel imaging system that enables multiple viewers to simultaneously view different images in full-screen mode on a single screen.

The present invention also provides a multi-channel imaging system that enables multiple viewers to simultaneously view different images in full-screen mode on a single screen without degradation in image resolution.

According to an aspect of the present invention, there is provided a multi-channel imaging system including: a mode selector which selects a general two-dimensional (2D) mode, a multi-channel 2D mode, or a three-dimensional (3D) mode; a source selector which provides an image of at least one channel selected by a user; a conversion unit which interlaces two images received from the source selector so that the two images alternate with each other when the multi-channel mode or the 3D mode is selected; a display which displays the alternating two images received from the conversion unit so that they have orthogonal polarizations; 3D polarizing glasses which provide a different image to the left and to the right eye when the 3D mode is selected; and a pair of multi-channel polarizing glasses each of which provides a user with only one of two images being displayed when the a multi-channel 2D mode is selected.

The display may include a liquid crystal display (LCD) panel which displays at least one image having specific polarization directions; and a multi-channel screen that is disposed in front of the LCD panel and includes a plurality of birefringence elements arranged at regular intervals which rotate the polarization direction of one of the two images being alternately displayed on the LCD panel by 90 degrees.

The birefringence element may include one a rotator which rotates incident light by 90 degrees or a retarder which delays the phase of incident light by λ/2.

The display may include: a non-polarizing display panel which displays at least one image having no polarization; and a multi-channel screen that is disposed in front of the display panel and includes first and second polarizing plates with orthogonal polarization directions arranged at regular intervals so that the two images being alternately displayed on the display panel have orthogonal polarizations.

The display panel may be a Plasma Display Panel (PDP), a Field Emission Display (FED) panel, or a Cathode Ray Tube (CRT) panel. When the multi-channel 2D mode is selected, the source selector may provide two images, selected by the user among images independently provided by a plurality of image sources, to the conversion unit. The plurality of image sources may include at least one of a TV channel, a VCR, a PC, and a DVD player.

When the multi-channel 2D mode is selected, the conversion unit downscales the resolution of the two images provided by the source selector and interlaces the two images so that they alternate with each other.

Alternatively, when the multi-channel 2D mode is selected, the conversion unit may repeat a first step of time-dividing the two images provided by the source selector, interlacing the odd lines of a first image of the two images and the even lines of a second image of the two images so that they alternate with each other and providing the alternating images to the display and a second step of interlacing the odd lines of the second image and the even lines of the first image so that they alternate with each other and providing the alternating images to the display. The conversion unit makes a frame rate of an image provided on the display after the interlacing process twice that of a frame rate of the image provided by the source selector, thus enabling multiple users to simultaneously view two images in full size on a single screen without degradation of the image resolution.

When the 3D mode is selected, the source selector provides a left eye image and a right eye image to the conversion unit. The conversion unit downscales the resolution of the left eye image and the right eye image provided by the source selector and interlaces the left and right eye images so that they alternate with each other.

Alternatively, when the 3D mode is selected, the conversion unit may repeat a first step of time-dividing the left eye image and the right eye image provided by the source selector, interlacing the odd lines of the left eye image and the even lines of the right eye image so that they alternate with each other, and providing the alternating images to the display and a second step of interlacing the odd lines of the right eye image and the even lines of the left eye image so that they alternate with each other and providing the alternating images to the display. The conversion unit makes a frame rate of an image provided on the display after the interlacing process double a frame rate of the image provided by the source selector, thus enabling a user to view a 3D image without degradation in image resolution.

The 3D polarizing glasses include left and right orthogonal polarizing plates.

The pair of multi-channel polarizing glasses includes first polarizing glasses having first left and right polarizing plates with a first polarization and second polarizing glasses having second left and right polarizing plates with a second polarization orthogonal to the first polarization. In the multi-channel 2D mode, the first polarizing glasses provide only a first image of the two images being displayed on the display to the user and the second polarizing glasses provide only a second image of the two images being displayed to the user.

### BRIEF DESCRIPTION OF THE DRAWINGS

The above and other aspects of the present invention will become more apparent by describing in detail exemplary embodiments thereof with reference to the attached drawings in which:

FIGS. 1A and 1B schematically illustrate screens for realizing multiple channels in a conventional split-screen multi-channel imaging system;

FIGS. 2 and 3 schematically show conventional multi-channel imaging systems supporting multiple channels in a full-screen;

FIG. 4 is a block diagram of a multi-channel imaging system according to an exemplary embodiment of the present invention;

FIGS. 5A-5E schematically show the constructions of a display in the multiple-channel imaging system of FIG. 4;

FIG. 6 schematically shows the construction of a conversion unit in the multiple-channel imaging system of FIG. 4;

FIG. 7 schematically shows a plurality of exemplary polarizing glasses used for imaging modes of a multi-channel imaging system;

FIGS. 8A and 8B schematically shows operations of a multi-channel imaging system in each imaging mode according to an exemplary embodiment of the present invention; and

FIG. 9 schematically shows the operation of a time-division multi-channel imaging system according to an exemplary embodiment of the present invention.

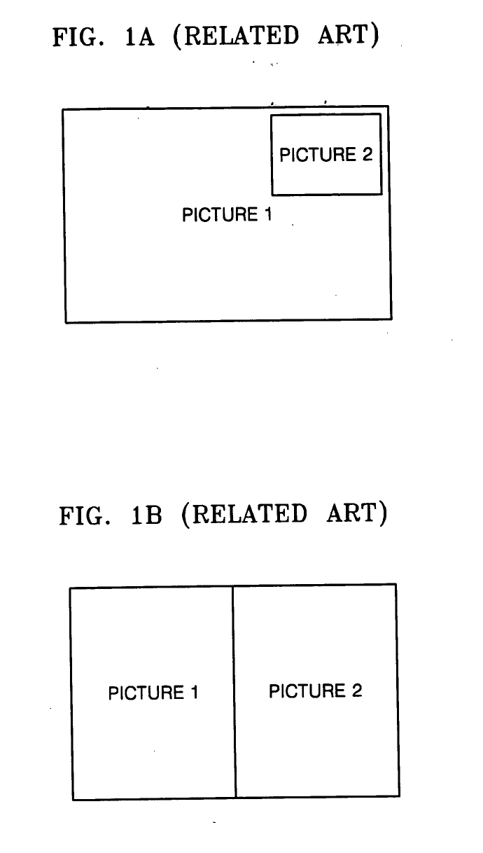

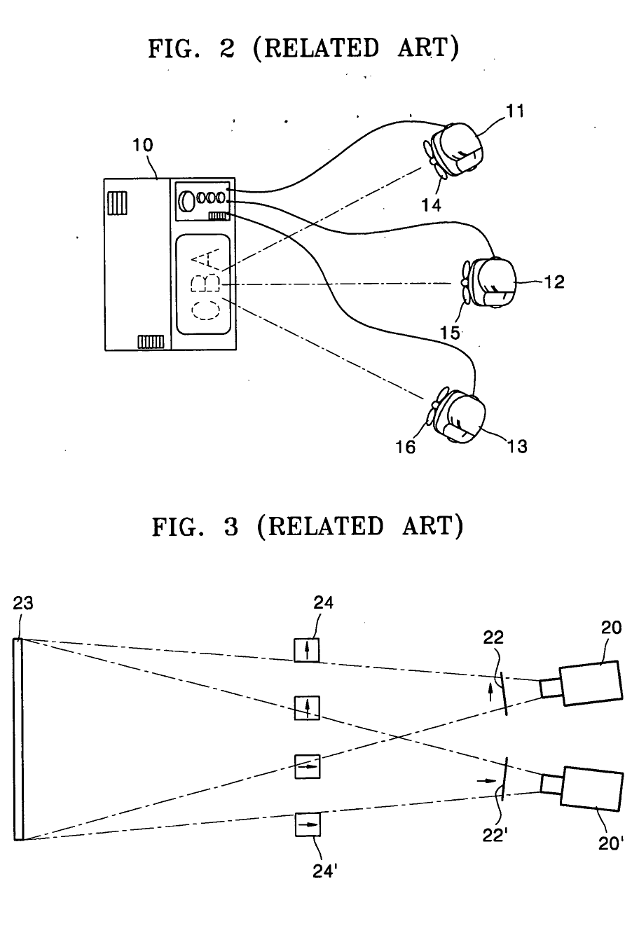

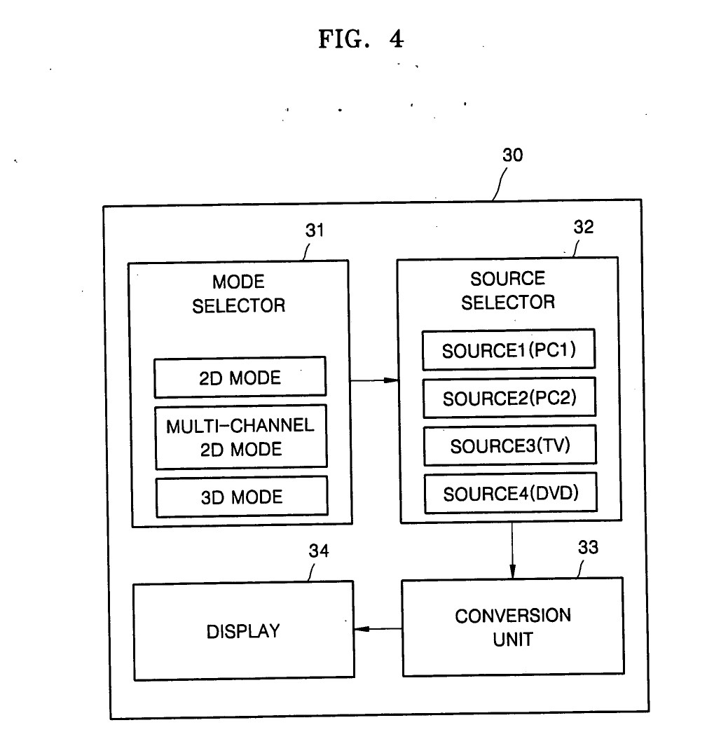

### DETAILED DESCRIPTION OF EXEMPLARY EMBODIMENTS OF THE INVENTION

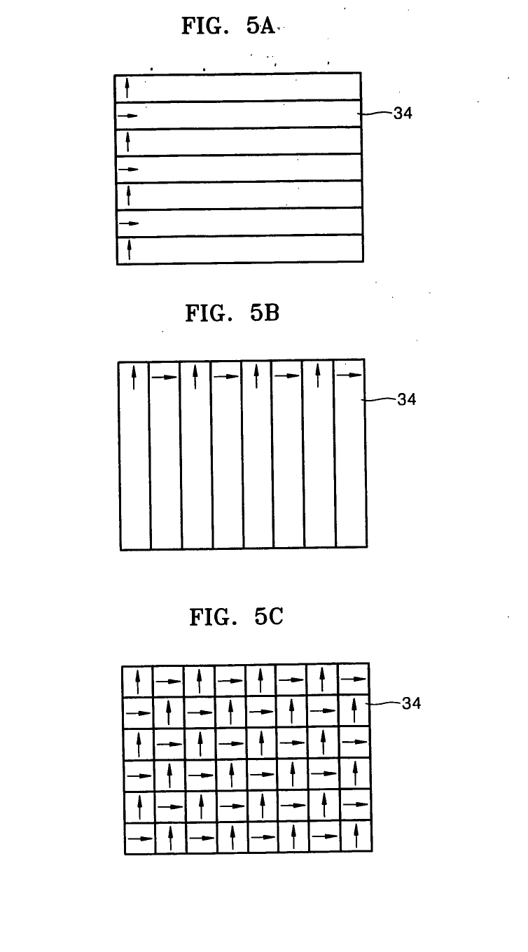

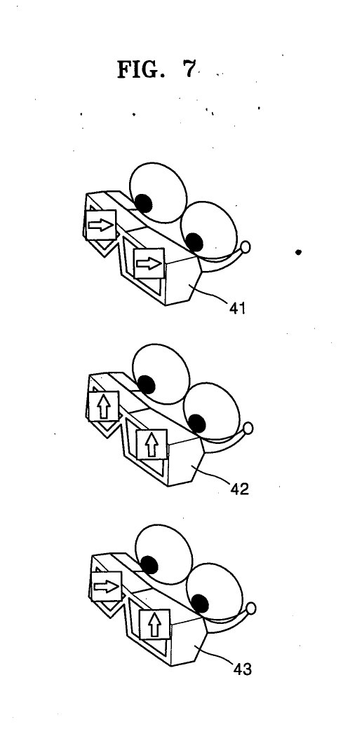

Referring to FIG. 4, a multi-channel imaging system 30 according to an exemplary embodiment of the present invention includes a mode selector 31 which selects operation modes; a source selector 32 which provides an image of at least one channel selected by a user; a conversion unit 33 which interlaces two images received from the source selector 32 so that they alternate with each other; and a display 34 which displays an image received from the conversion unit 33. As shown in FIG. 7, the multi-channel imaging system 30 further includes a set of polarizing glasses including a three-dimensional (3D) polarizing glasses 43 and a pair of multi-channel polarizing glasses 41 and 42. The mode selector 31 allows a user to select one of a general 2D mode, a multi-channel 2D mode, and a 3D mode so that the multi-channel imaging system 30 can operate in the selected mode. The source selector 32 allows a user to choose one or two images from image sources such as TV channel, VCR, PC, and DVD player according to an operation mode.

The multi-channel imaging system 30 operates on a principle similar to a stereoscopic image display system using polarizing glasses. In a typical stereoscopic image display system using polarizing glasses, left-eye image and right-eye image are interlaced so that the images alternate with each other and two interlaced images are displayed on a display so that the left-eye and right-eye images have orthogonal polarizations. The polarizing glasses having two orthogonal polarizing plates are used to present the separate left-eye and right-eye images to a user's left and right eyes.

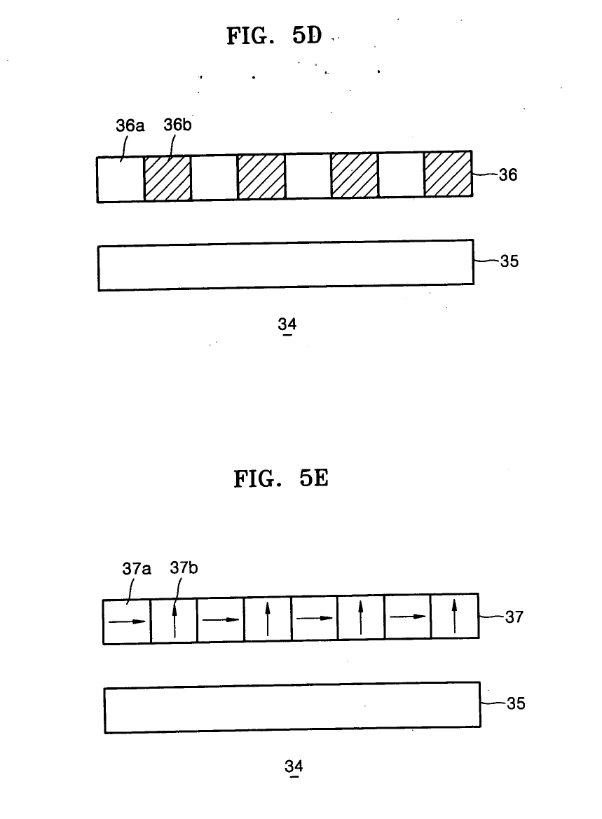

Similarly, the display 34 of the multi-channel imaging system 30 displays images of two channels received from the source selector 32 so that they have orthogonal polarizations. For example, as shown in FIG. 5A, the display 34 may alternately display images having vertical and horizontal polarizations in a longitudinal direction. As shown in FIG. 5B, the display 34 may alternately display images having vertical and horizontal polarizations in a transverse direction. Referring to FIG. 5C, the display 34 may alternately display images having vertical and horizontal polarizations in a square matrix. The conversion unit 33 interlaces two images received from the source selector 32 so that the two images alternate as shown in FIGS. 5A and 5C. The display 34 displays the images received from the conversion unit 33 while assigning specific polarization direction to the images being displayed.

To achieve this function, the display 34 includes a display panel 35 displaying an image and a multi-channel screen 36 or 37 assigning polarization to an image being displayed. The display panel 35 may be any type of display panel such as an LCD panel, a PDP, a FED panel, or a CRT panel. The multi-channel screen 36 or 37 is located in front of the display panel 35 and includes two types of optical elements arranged in the same pattern as two images are interlaced by the conversion unit 33. The two types of optical elements in the multi-channel screen 36 or 37 assign orthogonal polarizations to the two images.

For example, when the display 34 shown in FIG. 5D uses an LCD panel as the display panel 35, an image being displayed on the LCD panel already has polarization of specific direction. In this case, by rotating the polarization direction of one of two images by 90° while allowing the other image to pass through, the two images with two orthogonal polarizations can be obtained. To achieve this purpose, the multi-channel screen 36 may include a plurality of birefringence elements 36b arranged at regular intervals rotating the polarization direction of one of two images being alternately displayed on the display panel 35 by 90 degrees and transmissive plates 36a that are disposed between adjacent birefringence elements 36b and transmit the other image. The birefringence elements 36b may be rotators rotating incident light by 90 degrees or retarders delaying the phase of incident light by λ/2.

On the other hand, when an image being displayed on a display panel 35 such as a PDP, FED, or CRT panel does not have polarization, polarization can be assigned to two images using two polarizing plates having orthogonal polarizations. That is, as shown in FIG. 5E, the multi-channel screen 37 disposed in front of a non-polarizing display panel includes first and second polarizing plates 37a and 37b. having orthogonal polarization directions arranged at regular intervals.

FIG. 7 schematically shows a plurality of polarizing glasses used for imaging modes of a multi-channel imaging system. Referring to FIG. 7, two polarizing glasses 41 and 42 are a set of multi-channel polarizing glasses being used for a multi-channel 2D mode. For example, the first polarizing glasses 41 has first left and right polarizing plates transmitting only horizontal polarization components while the second polarizing glasses 42 has second left and right polarizing plates transmitting only vertical polarization components. Thus, a user who wears the first polarizing glasses 41 can view only an image formed by the horizontal polarization component while another user who wears the second polarizing glasses 42 can view only an image formed by the vertical polarization component. Thus, the multi-channel imaging system enables multiple users to view different images using a single display system. Third polarizing glasses 43 are 3D polarizing glasses for viewing a 3D image in a 3D mode and have left and right orthogonal polarizing plates. Thus, a user's left eye can see only a left eye image being displayed on the display 34 in a 3D mode and the right eye can see only a right eye image while wearing the third polarizing glasses 43, thus enabling a stereoscopic image.

The operation of the multi-channel imaging system 30 will now be described in more detail.

First, a user selects one of a general 2D mode, a multi-channel 2D mode, and a 3D mode through the mode selector 31. When the user selects the general 2D mode, the user selects one channel through the source selector 32 and observes an image being displayed on the display 34 without polarizing glasses. In this case, signal processing through the conversion unit 33 is not required.

When two or more users intend to view images from different channels on the same screen, a multi-channel 2D mode is selected. Then, each user selects a desired image from two channels or sources through the source selector 32. The user can select one of various image sources such as TV, PC, DVD player, and VCR according to desired service type. In particular, different channels on TV can be considered as different sources. Two image signals selected by the source selector 32 are scaled according to the resolution of the display 34 by the conversion unit 33 and are then displayed on the display 34.

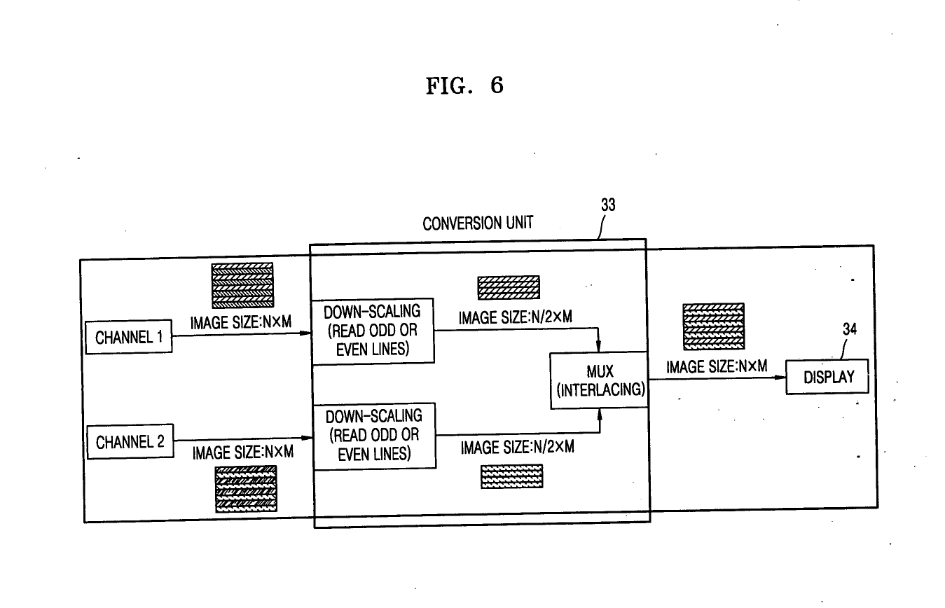

FIG. 6 illustrates the operation of the conversion unit 33. Referring to FIG. 6, assuming that the display 34 has an N×M resolution, signals input to the conversion unit from different channels are downscaled to a N/2×M resolution. Then, downscaled versions of images from two channels are interlaced by a multiplexer (Mux) so that the images alternate and are eventually displayed at the original resolution ( N×M) of the display 34. For convenience of explanation, FIG. 6 shows an example in which the odd and even lines of an image are polarization-encoded separately by the display 34 as shown in FIG. 5A. However, the conversion unit 33 may interlace two images as shown in FIGS. 5A-5C.

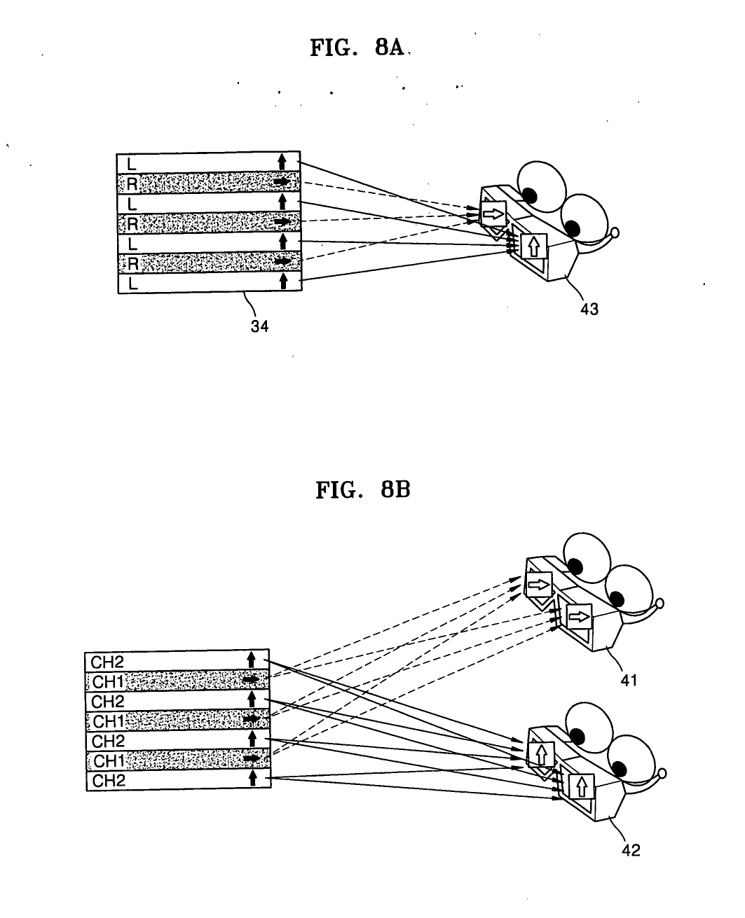

As a result, as shown in FIG. 8B, an image from channel 2 (CH2) may be displayed with vertical polarization on the odd lines of the display 34 while an image from channel 1 (CH1) may be displayed with horizontal polarization on the even lines. Thus, a user who desires to view the image from CH1 wears the first polarizing glasses 41 and another user who desires to see the image from CH2 wears the second polarizing glasses 42. The user wearing the first polarizing glasses 41, which block the image from CH2 having vertical polarization and allows the image from CH1 having horizontal polarization to pass through, can view only the image from CH1 without being irritated. The user wearing the second polarizing glasses 42 can see the image from CH2 without being annoyed due to the presence of an image from another channel.

A user who desires to view a stereoscopic image selects a 3D mode. The source selector 32 provides left eye image and a right eye image from a 3D channel selected by the user to the conversion unit 33. As in the multi-channel 2D mode, the conversion unit 33 downscales the resolutions of the left eye image and the right eye image received from the source selector 32 and interlaces the two images so that they alternate with each other before providing the alternating images to the display 34. In this case, the user wears the 3D polarizing glasses 43 to see the two images being displayed on the display 34 as shown in FIG. 8A, thereby perceiving a stereoscopic image.

As described above, the multi-channel imaging system 30 allows a user to select one of a general 2D screen, a multi-channel 2D screen, and a 3D screen and to view the desired image.

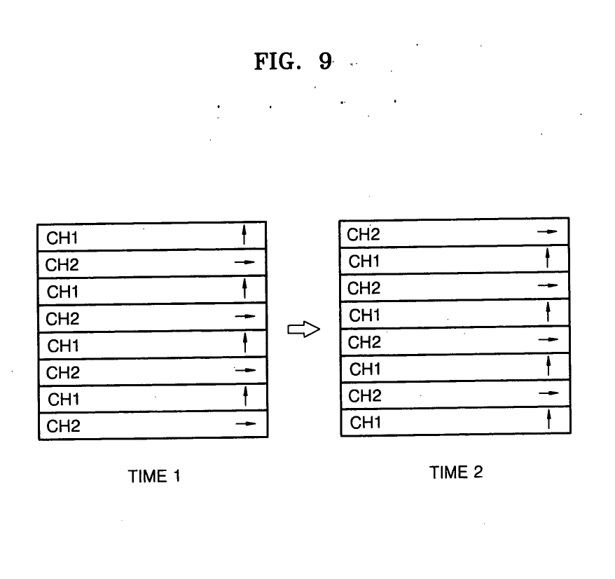

Images in the multi-channel 2D mode and the 3D screen have half the resolution of an image in the general 2D mode. Thus, to prevent degradation of resolution, an image can be displayed in a time-sharing manner as shown in FIG. 9. Referring to FIG. 9, at time 1, the conversion unit 33 interlaces the odd lines of an image from CH1 and the even lines of an image from CH2 so that they alternate with each other and provides the interlaced images to the display 34. At time 2, the conversion unit 33 interlaces the odd lines of the image from CH2 and the even lines of the image from CH1 so that they alternate with each other and provides the interlaced images to the display 34.

When the period of time 1 or time 2 is half the time when two images are displayed on a screen in a general 2D mode, the original resolution of the image can be maintained. That is, the remaining portion of an image not displayed at time 1 due to the presence of an image from a different channel can be displayed at time 2 by repeatedly changing the display position of images from the two channels CH1 and CH2 over a short period. Thus, the entire image can be displayed without loss, thus preventing degradation in resolution.

Further, the display 34 repeatedly rotates the polarization direction of an image being displayed by 90 degrees or allows the image to pass through in synchronization with the speed of time-sharing display so that the images from CH1 and CH2 retain vertical and horizontal polarizations, respectively. To achieve this function, a polarization switch (not shown) may be disposed in front of the multi-channel screen 36 or 37 shown in FIG. 5D or 5E. The polarization switch being turned off allows light to pass through while the polarization switch being turned on rotates the polarization direction of light by 90 degrees. Thus, when the polarization switch is turned on or off repeatedly in synchronization with the speed of time-sharing display of an image, each image can always maintain the same polarization direction.

Like in the multi-channel 2D mode, in the 3D mode, the conversion unit 33 interlaces the odd lines of a left eye image and the even lines of a right eye image so that they alternate with each other and provides the interlaced images to the display 34. The conversion unit 33 also interlaces the odd lines of the right eye image and the even lines of the left eye image so that they alternate with each other and provides the interlaced images. The conversion unit 33 repeats the above processes. A polarization switch is turned on or off repeatedly in synchronization with the alternating display of two images, thereby allowing a user to view a stereoscopic image without degradation in resolution.

While FIG. 9 shows the time-sharing display method applied to a case in which the display 34 separately polarization-encodes the even and odd lines of an image, the same method can also be applied to cases in which images are interlaced as shown in FIG. 5B or 5C.

While in the above description an image being displayed on the display 34 has a linear polarization, the principle of the present invention can apply when an image has a circular polarization.

As described above, the multi-channel imaging system according to an exemplary embodiment of the present invention allows multiple viewers to simultaneously view images from different channels in full size on a single screen using a simple method compared to a conventional imaging system. Furthermore, the multi-channel imaging system uses a time-sharing display method to allow multiple users to simultaneously see images from different channels in full size on a single screen without degradation in image resolution.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-channel imaging system comprising:
a mode selector which selects one of a general two-dimensional (2D) mode, a multi-channel 2D mode, and a three-dimensional (3D) mode;
a source selector which provides an image from at least one channel selected by a user;
a conversion unit which interlaces first and second images received from the source selector so that the first and second images alternate with each other if the multi-channel 2D mode or the 3D mode is selected;
a display which displays the alternating first and second images received from the conversion unit so that the first and second images have orthogonal polarizations; and
3D polarizing glasses which provide only the first image to the left eye of a user and provide only the second image to the right eye of the user if the 3D mode is selected; and
first and second polarizing glasses, the first polarizing glasses providing only the first image displayed by the display to the user and the second polarizing glasses providing only the second image displayed by the display to the user if the a multi-channel 2D mode is selected.

2. The system of claim 1, wherein the display comprises:
a liquid crystal display (LCD) panel which displays at least one image having specific polarization directions; and
a multi-channel screen that is disposed in front of the LCD panel and comprises a plurality of birefringence elements arranged at regular intervals which rotate the polarization direction of one of the two images being alternately displayed on the LCD panel by 90 degrees.

3. The system of claim 2, wherein each of the birefringence elements comprises a rotator which rotates incident light by 90 degrees or a retarder which delays a phase of incident light by λ/2.

4. The system of claim 1, wherein the display comprises:
a non-polarizing display panel which displays at least one image having no polarization; and
a multi-channel screen that is disposed in front of the display panel and comprises first and second polarizing plates with orthogonal polarization directions arranged at regular intervals so that the two images being alternately displayed on the display panel have orthogonal polarizations.

5. The system of claim 4, wherein the display panel is a Plasma Display Panel, a Field Emission Display panel, or a Cathode Ray Tube panel.

6. The system of claim 1, wherein if the multi-channel 2D mode is selected, the source selector provides the first and second images, which are selected by the user among images independently provided by a plurality of image sources, to the conversion unit.

7. The system of claim 6, wherein the plurality of image sources includes at least one of a television channel, a video cassette recorder, a personal computer, and a digital versatile disc player.

8. The system of claim 6, wherein if the multi-channel 2D mode is selected, the conversion unit decreases the resolution of the first and second images provided by the source selector and interlaces the first and second images so that the first and second image alternate with each other.

9. The system of claim 6, wherein if the multi-channel 2D mode is selected, the conversion unit repeats a first process of time-dividing the first and second images provided by the source selector, interlacing odd lines of the first image and even lines of the second image so that the first and second image alternate with each other, and providing the alternating first and second images to the display, and a second process of interlacing odd lines of the second image and even lines of the first image so that the first and second images alternate with each other and providing the alternating first and second images to the display.

10. The system of claim 9, wherein the display further comprises a polarization switch which rotates a polarization direction of an image being displayed by 90 degrees or allows the image to be transmitted therethrough without a change in polarization through in synchronization with a speed at which the first and second processes are repeated.

11. The system of claim 1, wherein if the 3D mode is selected, the source selector provides a left eye image as the first image and a right eye image as the second image to the conversion unit.

12. The system of claim 11, wherein the conversion unit decreases a resolution of the left eye image and the right eye image provided by the source selector and interlaces the left and right eye images so that they alternate with each other.

13. The system of claim 11, wherein if the 3D mode is selected, the conversion unit repeats a first process of time-dividing the left eye image and the right eye image provided by the source selector, interlacing odd lines of the left eye image and even lines of the right eye image so that the left and right eye images alternate with each other, and providing the alternating left and right eye images to the display, and a second process of interlacing odd lines of the right eye image and even lines of the left eye image so that the left and right eye images alternate with each other and providing the alternating left and right eye images to the display.

14. The system of claim 13, wherein the display further comprises a polarization switch which rotates a polarization direction of an image being displayed by 90 degrees or allowing the image to be transmitted therethrough without a change in polarization in synchronization with a speed at which the first and second processes are repeated.

15. The system of claim 1, wherein the 3D polarizing glasses comprise left and right orthogonal polarizing plates.

16. The system of claim 1, wherein the first polarizing glasses comprise first left and right polarizing plates with a first polarization and the second polarizing glasses comprise second left and right polarizing plates with a second polarization orthogonal to the first polarization.

17. A multi-channel imaging system comprising:
a source selector which provides an image from two channels selected by a user;
a conversion unit which interlaces first and second images received from the source selector so that first and second two images alternate with each other;
a display which displays the alternating first and second images received from the conversion unit so that the first and second images have orthogonal polarizations;
first polarizing glasses which provide only the first image displayed by the display to a user; and
second polarizing glasses which provide only the second image displayed by the display to the user.

18. The system of claim 17, wherein the display comprises:
a liquid crystal display (LCD) panel which displays at least one image having specific polarization directions; and
a multi-channel screen that is disposed in front of the LCD panel and comprises a plurality of birefringence elements arranged at regular intervals which rotate the polarization direction of one of the two images being alternately displayed on the LCD panel by 90 degrees.

19. The system of claim 18, wherein each of the birefringence elements comprises a rotator which rotates incident light by 90 degrees or a retarder which delays a phase of incident light by λ/2.

20. The system of claim 17, wherein the display comprises:
a non-polarizing display panel which displays at least one image having no polarization; and
a multi-channel screen that is disposed in front of the display panel and comprises first and second polarizing plates with orthogonal polarization directions arranged at regular intervals so that the two images being alternately displayed on the display panel have orthogonal polarizations.

21. The system of claim 20, wherein the display panel is a Plasma Display Panel, a Field Emission Display panel, or a Cathode Ray Tube panel.

22. The system of claim 17, wherein the source selector provides the first and second images, which are selected by the user among images independently provided by a plurality of image sources, to the conversion unit.

23. The system of claim 22, wherein the plurality of image sources includes at least one of a television channel, a video cassette recorder, a personal computer, and a digital versatile disc player.

24. The system of claim 22, wherein the conversion unit decreases the resolution of the first and second images provided by the source selector and interlaces the first and second images so that the first and second images alternate with each other.

25. The system of claim 22, wherein the conversion unit repeats a first process of time-dividing the first and second images provided by the source selector, interlacing odd lines of the first image and even lines of the second image so that the first and second image alternate with each other, and providing the alternating images to the display and a second process of interlacing odd lines of the second image and even lines of the first image so that the first and second images alternate with each other and providing the alternating first and second images to the display.

26. The system of claim 25, wherein the display further comprises a polarization switch which rotates a polarization direction of an image being displayed by 90 degrees or allows the image to be transmitted therethrough without a change in polarization through in synchronization with a speed at which the first and second processes are repeated.

27. The system of claim 17, wherein the first polarizing glasses comprise first left and right polarizing plates with a first polarization and the second polarizing glasses comprise second left and right polarizing plates with a second polarization orthogonal to the first polarization.
